(19) United States
(12) Patent Application Publication
(10) Pub. No.: US 2008/0244689 A1
(43) Pub. Date: Oct. 2, 2008

(54) Extensible Ubiquitous Secure Operating Environment

(76) Inventor: Curtis Everett Dalton, Georgetown, MA (US)

Correspondence Address: CURTIS E. DALTON, 3 ABBEY ROAD, GEORGETOWN, MA, 01833, US

(21) Appl. No.: 11/694,859

(22) Filed: Mar. 30, 2007

(51) Int. Cl. H04L 9/00

(52) U.S. Cl. 726/1

(57) ABSTRACT

The present invention provides a portable and secure computer operating system, and applications that can be used securely on virtually any computer system regardless of its security state (i.e., regardless of the presence of computer viruses, Trojan code, keylogging software, or any other malicious mobile code that may exist on host computer system). The present invention is embodied within three (3) components including 1) the client desktop or server software, 2) the appliance-based management server, and 3) the media (i.e., including but not limited to USB thumb drive or CDROM) on which the client desktop or server software is installed.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO SEQUENCE LISTING, A TABLE, OR COMPUTER PROGRAM LISTING

Not applicable.

### BACKGROUND OF THE INVENTION

The present invention pertains to the field of computer information security, and particularly, to computer information security solutions that secure the host operating system; secure the host applications; and secure user sessions and communications.

Problems this Invention Addresses:
Banks desire a method of ensuring their online banking is secure.
Public and private sector organizations desire an effective, inexpensive disaster recovery solution.
Public and private sector organizations need to ensure that Personally Identifiable Information is not compromised.
Call Centers desire a streamlined, inexpensive desktop provisioning process.
Internet Cafés (i.e., Starbucks™, Panera Bread™, Au Bon Pain™, and others) would benefit from co-branded tokens that permit authorized, secure, wireless network connectivity within their stores.
Traveling professionals, including but not limited to law enforcement, military, and sales persons or teleworkers, would benefit from the ability to securely use any public computer system including public kiosk systems.
Extends computer notebook/laptop battery life when used with the USB thumb drive embodiment of this invention since there are no moving parts; the computer hard disk is spun down and disabled, and the CD/DVD drive is also disabled.

Commercial businesses, government agencies (federal, state, local, county), and the military are legally required to enact and enforce effective security policies and controls that protect Personally Identifiable Information (e.g., Sarbanes-Oxley, HIPAA, PCI, GLBA, FERPA). Additionally, businesses, government, and military organizations desire the ability to provide secure server infrastructure solutions to customers, business associates, staff, and the public at large. Mitigating computer security risks (e.g., patching, firewalling) never entirely solves the problem because information security is only a slice in time (a computer system is only ‘secure’ until an exploit or vulnerability is uncovered). Attackers are numerous and proficient, and the threat window (time between an exploit discovery by hackers, and the availability and installation of a patch to resolve the security deficiency) is increasing each year. Additionally, the administrative (equipment capital costs plus labor costs) and liability costs (cost of security breach plus insurances and brand name destruction) to provision and maintain deployed computer systems is high. These factors lay a heavy burden on organizations. While many point solutions exist, no known solution exists today that entirely solves the security problems identified above. Some examples of point solutions include Anti-virus software, which is always one step behind the attacker; intrusion detection solutions, which are also signature based and therefore also one step behind the attacker as well as being interpretive and often misleading; zero-day technologies that utilize heuristics and behavior tracking are immature; and firewalls, including personal firewalls, do not effectively examine application layers and content security; Full disk encryption (FDE) solutions, which encrypt the contents of a computer system's hard disk, are immature, unproven, and the logistics and complications of managing, administering, and recovering user data within such a solution are costly in labor effort and services dollars. Additionally, the security management of FDE solutions is unproven, and represents a likely attack vector for hackers. None of these solutions fully prevent the breach of information (i.e., PII) on a computer host when the computer is in the physical possession of an attacker. Organizations require solutions that address and resolve these security issues. This invention approaches the existing deficiencies of computer security at the root by addressing the cause of computer in-security instead of treating the symptoms.

### REFERENCES CITED

US PATENT DOCUMENTS

| | | |
|---|---|---|
| 7,174,457 | Feb. 6, 2007 | England, et al |
| 6,681,324 | Jan. 20, 2004 | Anderson |
| 7,152,156 | Dec. 19, 2006 | Babbitt, et al |
| 6,999,913 | Feb. 14, 2006 | Hensley |
| 6,996,706 | Feb. 7, 2006 | Madden, et al |
| 6,920,553 | Jul. 19, 2005 | Poisner |

### OTHER REFERENCES

Best Current Practices of XCAST (Explicit Multi-Unicast) by 2004, IETF Internet Draft (draft-hsu-xcast-bcp-2004-01.txt), July 2005, by Hsu, et al.
International Business Machines, Split-memory facility for Windows NT(tm), May 1999, Research Disclosure Journal.
A computer floppy disk program/data file system, August 1988, Research Disclosure Journal.
Stuckelberg et al, Linux Remote-Boot mini-HOWTO: v3.19, February 1999.
Porkka Joe, Boot disk optimizer?, Apr. 12, 1991.
Smits Ron, The Making of a bootable floppy, Feb. 1, 1994, pp. 1-4.
Chapman Graham, The Linux Bootdisk HOWTO, Feb. 6, 1995, pp. 1-7.
Neilsen Mark, How to use a Ramdisk for Linux, Nov. 1, 1999, pp. 1-4.
Rembo Technology, LoadRamDisk, 2000.
Nutt Gary J, Operating Systems: A Modern Perspective, 2000, Addison-Wesley, 2.sup.nd ed., pp. 293-299.
Preboot Execution Environment (PXE) Specification, Version 2.1, table of contents and pp. 71-101; Sep. 20, 1999.

### BRIEF SUMMARY OF THE INVENTION

The present invention addresses the inherent information security risks associated with general purpose computer systems (GPCS), whether user-based or server-based, by attacking the problem at the root cause rather than by addressing the symptoms of computer in-security as is done with numerous available solutions today such as signature-based anti-virus and intrusion detection, endless operating system and application patching, and port/protocol-based firewalls. The present invention is embodied within three (3) components including 1) the EUSOE client desktop or server software (EC), 2) the EUSOE appliance-based management server (EMS), and 3) the media (i.e., including but not limited to USB thumb drive or CDROM) on which the client desktop or server software is installed. The EC includes an encrypted, password protected, hardened, pre-loaded, bootable ISO image of the host operating system and select applications that are authorized for the desktop user or server; a digital certificate (unique public and private key pair signed by the EMS private key); the EMS public key; and any other third party digital certificates that the customer may require. The encrypted and password protected EC image is digitally signed by the EMS private key at time of creation of the EC to ensure its authenticity when in physical possession of the EC. Additionally, each file within the EC image is digitally signed by the EMS private key during creation of the EC image to provide the ability to verify the authenticity of a booted EC when communicating (network attached) with the EMS.

This invention provides an extensible, ubiquitous, secure operating environment for use on virtually any computer system, and requires no installation on the host device. This invention is extensible since varying degrees of security control can be applied at time of boot image creation including but not limited to determination of acceptable authentication criteria, network usage criteria, application usage criteria, disablement of any one or more of USB, CD/DVD, wireless, LAN, Infrared devices etc, as appropriate; ubiquitous since virtually any un-secured computer (any computer system lacking adequate access controls such as a public kiosk system, infected with viruses or worms, infected with key loggers or Spyware, or all of the above, etc) system can be securely used with this technology without installing it to the host computer; secure since the operating system and applications have been appropriately hardened (configured) prior to image creation, encrypted and password protected accessible only by supplying the authorized boot password prior to its use. Once the secure boot image is written to the media (i.e., including but not limited to USB thumb drive or CDROM), it is encrypted and digitally signed by the EMS private key such that any attempted alteration of its content would invalidate it during the EC validation phase described herein. In one embodiment of the invention, a portion of the USB is used for user data storage and is digitally encrypted allowing only the EC owner access to this content. In either embodiment, the invention's client or server software cannot be altered and therefore cannot become infected. Additionally, this invention secures user session activities since it does not permit the capture, logging, or storage of user session data on the host system. The result of securing a user session in this manner is that an attacker (or any unauthorized personnel) who conducts a computer forensic examination on the computer system will not be able to retrieve any of the user's session data or determine any of the activities conducted during the EC user's session.

### BRIEF DESCRIPTION OF THE SEVERAL VIEWS OF THE DRAWING

Not applicable.

### DETAILED DESCRIPTION OF THE INVENTION

The invention, Extensible Ubiquitous Secure Operating Environment (EUSOE), is embodied within 1) the EUSOE client desktop or server software (EC), and 2) the EUSOE appliance-based management server (EMS). The EC software is installed to commercial off the shelf (COTS) media (i.e., including but not limited to USB thumb drive or CDROM).

The two components of the EC include the desktop solution which provides for a secure desktop operating environment, and the server solution which provides for a secure server operating environment. In either case, the EC is purpose-built on the EMS and includes an encrypted, password protected, hardened, pre-loaded, bootable ISO image of the host operating system and select applications that are authorized for the desktop user or server; a digital certificate (unique public and private key pair signed by the EMS private key); the EMS public key; and any other third party digital certificates that the customer may require. The encrypted and password protected EC image is digitally signed by the EMS private key at time of creation of the EC to ensure its authenticity when in physical possession of the EC. Additionally, each file within the EC image is digitally signed by the EMS private key during creation of the EC image to provide the ability to verify the authenticity of a booted EC when communicating (network attached) with the EMS; and the EC also contains any third party digital certificates and keys that the customer may require for other purposes outside the scope of this invention.

The creation of the EC software is facilitated by one or more of the available open source (i.e., Linux, or FreeBSD) solutions such as SLAX, PCLinuxOS, Ubuntu, FreeSBIE, or Gentoo, with the software embodied within this invention. The software embodied within this invention does not alter any open source software with which it functions, nor is this open source software modified in any way prior to use with this invention. Rather, the EUSOE software is programmed to work within the open source application's API (application programmable interface). After the EC software ISO image is created it is encrypted, password protected, and digitally signed by the EMS private key then it is ‘burned’ (e.g., copied) to CDROM or USB thumb drive (similar media technologies that may not exist at time of this writing will also suffice).

In use, the EMS administrator configures the EC image on the EMS server via the EMS user interface and assigns the EC boot password. The EC image, EC digital certificate, EMS signed digital hash of the EC image, EMS public key, and user to which the image will be assigned, are saved on the EMS within the image library. Once the EC image and associated digital certificates are created, the EMS ‘burns’ (e.g., copies) these to the selected media (i.e., USB thumb drive, CDROM, or other). The resulting EC media is then distributed to the assigned user. The EMS administrator manages the deployed EC images to include: the online validation of EC's via the EMS assigned digital certificate on the EC; and the revocation of EC digital certificate for the purpose of disabling an EC. The EMS administrator can disable an EC by revoking their digital certificate and publishing this revocation via either CRL (certificate revocation list) or OCSP (RFC 2560). Details pertaining to the revocation process are further defined below within the EC operation description.

In use, the EC media (i.e., media includes but is not limited to USB thumb drive or CDROM) is inserted into the host computer system. Prior to granting network access, both the EC software and its user must be authenticated.

Authentication of the EC software begins with the host computer being booted by the EC media. The user is queried to enter their assigned boot password to authorize the booting of the EC software. If more than ten EC boot passwords are attempted, the EC disables itself by denying further logon attempts (note that disablement of the EC is only possible within the USB embodiment of this invention as the CDROM embodiment, or other read only media, cannot be written to). If the appropriate EC boot password is entered within ten attempts, the EC operating environment boots and establishes an SSL session with the EMS. The EC presents its EMS signed digital certificate for authentication. The EC digital certificate is then verified as authentic or not and its revocation status is verified by either CRL or OCSP method managed by the EMS. The EMS then verifies the digital signature of the files within the EC image. If any of these authentication steps are unable to validate the authenticity of the EC software, then the EC's digital certificate is disabled on the EMS and further connection attempts from the EC to the EMS are denied. If the EC is proven to be authentic by these steps, then the pre-configured network connection options are presented to the EC user. Network connection options are hard-coded within the EC image by the EMS administrator during the EC image creation process. EC network connection options include but are not limited to LAN, WLAN, VPN, Internet, Web application, etc.

Authentication of the EC user session requires presentation of username and password plus EMS issued digital certificate. In another embodiment, authentication of the EC session requires username and password plus either a third-party OTP (one time password via token) or biometric authentication criteria. In another embodiment, authentication of the EC session requires username and password plus third-party digital certificate. In another embodiment, authentication of the EC session requires only username and password. When the EC user session is authenticated, the EC is granted access to the appropriate network resources. After the EC user session is complete, the EC media can be removed from the host computer system. Since EC session activities are not captured, logged, or otherwise stored on the local computer system, an attacker who performs a digital forensic examination of the computer system will not collect any EC related data or session logs.

The appliance-based EMS, also embodied within this invention, is comprised of software that is installed on a purpose-built computer system (appliance). The purpose of the EMS is 1) the configuration of EC images, 2) the creation of EC images, 3) the burning of EC images to media (i.e., including but not limited to USB thumb drive or CDROM), 4) the management of various EC images within a library, 5) and the authorization and revocation of EC's via digital certificate revocation (accomplished via publication of a Certificate Revocation List, via the OCSP protocol, or other means) and verification of the digital signature of the files within the EC. The EMS operating system is either open source (Linux, FreeBSD, other), or Microsoft Windows™, and includes software embodied within this invention including the EMS application and an unaltered open source or native third-party Certificate Authority software component that accomplishes the above purposes relating to certificate creation, issuance, and revocation. External (e.g., non-native) third-party Certificate Authorities are also supported within the embodiment of this invention. In the preferred embodiment of this invention, the EMS is network connected (e.g., LAN, WLAN, and/or Internet connected as appropriate to the owner's purpose). In use, the EMS administrator accesses the EMS user interface to create, configure, and manage the EC ISO images. The EMS user interface is used to customize EC images prior to ‘burning’ (e.g., copying) them to the EC media. Such customization includes but is not limited to operating system settings, network connectivity settings, and application settings according to the need. The EMS maintains a library of all image configuration options, categorizing and saving the created images for future use and reference including the creation and use of image templates that are used to create various iterations of EC images. The EMS also creates, issues, and revokes digital certificates and manages the certificate revocation list (CRL) and OCSP responder, which are used to validate or invalidate EC's. Multiple EMS's can be configured to support one another creating a highly available solution where the certificate revocation list or OCSP responder is updated among the group, and the EC image creation, burning, and storage tasks can be shared among the group.

The media (i.e., EC media including but not limited to USB thumb drive or CDROM), onto which the EC software is installed, is a component of the solution but is not part of the embodied invention. Such media is commercial off the shelf (COTS), and houses the EC software for distribution. In one embodiment of this invention, EC images would be available via network boot, thereby eliminating the need for the above media in such scenarios.

This invention provides for several embodiments (distinct products) which include 1) a secure online banking product, 2) a disaster recovery product, 3) a PII security product, 4) a call center product, 5) an Internet café security product, and 6) a remote access security product. Each of the above presently identified embodiments of this invention are comprised of the same underpinning technology; the EMS and its associated computer appliance on which it operates is built and operates in the same manner within each embodiment listed. The EC software, however, is altered in each case as to present the user with applicable network connection options and applicable application presentation capabilities that are pertinent to the given embodiment. These EC embodiments are described below.

The secure online banking embodiment of this invention is identical to the EC specification detailed previously, except that the user is presented with only the secure online (SSL, TSL, or similar) Web connection option that specifically directs the user to their online banking Web presence. All other EC build steps and its operation remains as previously specified.

The disaster recovery embodiment of this invention is identical to the EC specification detailed previously, except that the user is presented with only the secure online (IPSec, SSL, TSL, or similar) Web connection option that specifically directs the user to their disaster recovery server(s) where a Web interface, terminal services, Citrix™ connection, or other customer offered application service provides the user with an interface to their organization's site. All other EC build steps and its operation remains as previously specified.

The PII (personally identifiable information) security embodiment of this invention is identical to the EC specification detailed previously, except that the user is presented with only a LAN or WLAN access connection to their organization's local area network resources. All other EC build steps and its operation remains as previously specified.

The call center embodiment of this invention is identical to the EC specification detailed previously, except that the user is presented with only a LAN or WLAN access connection to their organization's call center application server(s). All other EC build steps and its operation remains as previously specified.

The Internet café security embodiment of this invention is identical to the EC specification detailed previously, except that the user is presented with only a secure WLAN access connection to the café's wireless network resources, and the EC media is co-branded by the customer. All other EC build steps and its operation remains as previously specified.

The remote access security embodiment of this invention is identical to the EC specification detailed previously, except that the user is presented with only secure online (IPSec, SSL, TSL, or similar) VPN or Web connection options that specifically direct the user to their organization's VPN gateway or Web-based remote access server. All other EC build steps and its operation remains as previously specified.

Those skilled in the art will understand that the preferred embodiments, as described hereinabove, may be subjected to apparent modifications without departing from the true scope and spirit of the invention. Accordingly, the inventor hereby declares his intention to rely upon the Doctrine of Equivalents, in order to protect his full rights in the invention.

### DRAWINGS

Not Applicable.

### OATH OR DECLARATION

Please see attached forms PTO/SB/01 (02-07), and PTO-1209.

What is claimed is:

1. A method of providing extensible security to the host computer system without requiring the installation of software, comprising: the assignment of varying degrees of security controls during the creation of the boot image and in its use including but not limited to the assignment of authorized authentication criteria, authorized network connection criteria, authorized application usage criteria, allow or permit use of host attached devices such as USB, CD/DVD, wireless 802.1x, and LAN.

2. The method of claim 1, wherein the software stored on a storage medium or network accessible server is encrypted and digitally signed such that any attempted alteration of the software would invalidate the digital signature.

3. The method of claim 2, wherein a portion of the storage medium has been reserved for user or system local data storage and is encrypted.

4. A method of providing ubiquitous use of computer systems without requiring the installation of software, comprising: software installed on a removable non-volatile storage medium or is network accessible which provides for the boot and operation of the host operating system, applications, and digital certificate housed on the storage medium.

5. A method of providing the host computer with protection from installed or malicious mobile programs without requiring the installation of software, comprising: software that is installed on a storage medium or is network accessible that is used to boot and operate the host computer.

6. A method of preventing the collection, processing, or storage of the host computer operating system, user's logon session, and application activities including but not limited to operating system logs, application logs, user logon and activity session logs, comprising: software installed on a removable non-volatile storage medium or is network accessible which provides for the boot and operation of the host operating system, applications, and digital certificate.

7. A method of providing secure remote access to a network without requiring the installation of software on the host computer, comprising:
software that is installed on a removable non-volatile storage medium or is network accessible which provides for the boot and operation of the host operating system, applications, and digital certificate housed on the storage medium.
